(19) United States
(12) Patent Application Publication
(10) Pub. No.: US 2016/0260126 A1
(43) Pub. Date: Sep. 8, 2016

(54) CAPTIVE NETWORK OF ADVERTISING AFFILIATES

(71) Applicant: Steven V. Shelburne, San Marino, CA (US)

(72) Inventor: Steven V. Shelburne, San Marino, CA (US)

(21) Appl. No.: 15/062,074

(22) Filed: Mar. 5, 2016

Related U.S. Application Data
(60) Provisional application No. 62/129,867, filed on Mar. 8, 2015.

(51) Int. Cl. G06Q 30/02; G06Q 30/06

(52) U.S. Cl. CPC G06Q 30/0253; G06Q 30/0613

(57) ABSTRACT

A method includes providing at least one of goods and services on an e-commerce website. A selection is received for displaying at least one of a particular good and a particular service. At least one customized web page is created for displaying at least one of the particular good and the particular service based on the e-commerce website. The customized web page is associated with an affiliate advertiser. A graphical code or a link is generated for display on the at least one web page. The at least one web page is displayed on a display device at a particular location. A selection is received for a transaction for at least one of the particular good and the particular service from another web page on the e-commerce website that is launched based on conversion of the graphical code or the link.

### CROSS-REFERENCE TO RELATED APPLICATIONS

This application claims the priority benefit of U.S. Provisional Patent Application Ser. No. 62/129,867, filed Mar. 8, 2015, incorporated herein by reference in its entirety.

### BACKGROUND

Current advertising practice can generally be categorized in two ways: broadcast (mass media), or narrow-cast (targeted). Examples of broadcast advertising are: network television commercials, outdoor boards or billboards, newspaper ads, and radio spots. To be sure, these ads are intended for a specific consumer segment (e.g., ads promoting a particular brand of motor oil during a television broadcast of an automobile race are ideally targeted towards those people who own a car).

Although the majority of broadcast ads are for products that a majority of the population can use, there is no convenient way for an advertising agency or advertiser to limit who might see the ad (e.g., young adults watching the evening news will most likely be exposed to ads for pharmaceuticals targeted to the elderly). This is acceptable to the advertiser, but because of the rather large net cast to catch the attention of the right consumer (e.g., advertising diapers to women who have or are about to have a baby), the expense for broadcast advertising is relatively high (e.g., advertising to all women of child bearing age). On the other hand, targeted advertising is much more cost effective, but correspondingly, influences a much smaller audience. Examples of the types of targeted, narrow-cast, advertising are direct mail, ads in enthusiast or special interest magazines, some cable-TV ads, and in the Internet world, “opt-in” e-mail distributions, search engine ads, display and banner ads, various keyword hyperlink ads, and even “pre-roll” commercials attached to video clips. The overwhelming majority of advertising on the Internet is “search”-related advertising, where the potential buyer is, or had been, scouting out a particular product or service using a search engine. Therefore, Internet advertising is vastly more targeted, and receptive to buyers searching for a product, as opposed to broadcast advertising where products are essentially searching for a buyer.

“Click-through” ads, the method by which most search-related ads work, generate billions of dollars in revenue for online advertisers and search engine companies. Very often they are effective, but there also have been problems with individuals or groups who have exploited the system to benefit the firm displaying the ads at the cost of the companies advertising their goods and/or services. This has been a significant concern with respect to “pay-per-click” advertising over the years.

### SUMMARY

Embodiments relate to a “captive network of advertising affiliates” (“CNAA”). One embodiment includes a method comprising providing at least one of goods and services on an e-commerce website. A selection is received for displaying at least one of a particular good and a particular service. At least one customized web page is created for displaying at least one of the particular good and the particular service based on the e-commerce website. The customized web page is associated with an affiliate advertiser. A graphical code or a link is generated for display on the at least one web page. The at least one web page is displayed on a display device at a particular location. A selection is received for a transaction for at least one of the particular good and the particular service from another web page on the e-commerce website that is launched based on conversion of the graphical code or the link.

Another embodiment includes a non-transitory processor-readable medium that includes a program that when executed by a processor performs a method including receiving a selection for displaying at least one of a particular good and a particular service from an e-commerce website. At least one customized web page is created for displaying at least one of the particular good and the particular service based on the e-commerce website. The at least one customized web page is associated with an affiliate advertiser. An object or signal is generated for the at least one customized web page. The at least one customized web page is displayed on a display device at a particular location. Receiving a selection for a transaction for at least one of the particular good and the particular service from another web page on the e-commerce website that is launched based on conversion of the object or the signal.

Yet another embodiment includes a memory device that stores instructions. One or more processors are configured to execute the instructions to: receive a selection for displaying at least one of a particular good and a particular service from an e-commerce website; create at least one customized web page for displaying at least one of the particular good and the particular service based on the e-commerce website, wherein the at least one customized web page associated with an affiliate advertiser; generate an object or signal on the at least one customized web page; display the at least one customized web page on a display device at a particular location; and receive a selection for a transaction for at least one of the particular good and the particular service.

These and other features, aspects and advantages of the present invention will become understood with reference to the following description, appended claims and accompanying figures.

### BRIEF DESCRIPTION OF THE DRAWINGS

FIG. 1 illustrates a captive network of advertising affiliates (CNAA) system, according to an embodiment;

FIG. 2 illustrates an example e-commerce system that may be implemented by an embodiment;

FIG. 3 illustrates an example web page displayed on a video monitor(s);

FIG. 4 illustrates a portable computing device connected to, and displaying an example of a web page on an e-commerce website that may be implemented by an embodiment;

FIG. 5 illustrates a block diagram of a process for an advertising affiliate creating a web page and displaying the web page for advertising goods and/or services selected from an e-commerce website, according to an embodiment;

FIG. 6 illustrates a block diagram of a process for utilizing information derived from an advertising affiliate-created e-commerce website web page, according to an embodiment;

FIG. 7 depicts a cloud computing node, according to an embodiment;

FIG. 8 depicts a cloud computing environment, according to an embodiment; and

FIG. 9 depicts a set of abstraction model layers, according to an embodiment;

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

One or more embodiments include a CNAA network. One embodiment includes providing at least one of goods and services on an e-commerce website. A selection is received for displaying at least one of a particular good and a particular service. At least one customized web page is created for displaying at least one of the particular good and the particular service based on the e-commerce website. The customized web page is associated with an affiliate advertiser. A graphical code or a link is generated for display on the at least one customized web page. The at least one customized web page is displayed on a display device at a particular location. A selection is received for a transaction for at least one of the particular good and the particular service from another web page on the e-commerce website that is launched based on conversion of the graphical code or the link

The term “captive” referred to herein may include serving a single company exclusively, and in one example an e-commerce website. The term “network” referred to herein may include any system or group of interrelated or interconnected elements, especially over a large area, such as the Internet, a general wide area network (WAN), etc. The term “advertising” referred to herein may include the activity of attracting public attention to a product or business, such as by paid announcements in the print, broadcast, or electronic media, and in one example displaying a web page as an advertisement on a video monitor with a “direct-response” call-to-action requiring a mobile electronic device (e.g., a smart phone, a wearable device, a tablet, etc.) to interact with information contained within the advertisement to access an e-commerce website.

The term “affiliate(s)” referred to herein may include a person, organization, or establishment associated with another as a subordinate, subsidiary, or member, and in one example a third-party affiliate acting as an advertiser for a first-party e-commerce website. The term “video monitor” referred to herein may include any of a computer (desktop, laptop, tablet, etc.) monitor, a projected image and/or a smart television (TV), such as a smart TV with web browser capabilities. The term “web page” referred to herein may include any of various hypertext markup language (HTML) based documents displayed in a static or dynamic format, and in one example a page created via accessing the World Wide Web.

The term “graphical code” referred to herein may include any of various bar codes, but preferably a quick response (QR) code. The term “portable computing device” referred to herein may include any of smart phone, laptop computer, tablet computer, wearable device (e.g., smart watch), or devices such as a GOOGLE GLASS®. The term “text string” referred to herein may include any of an alphanumeric string or uniform resource locator (URL).

Over the past 15 years, search engines have become so good that you can find just about anything you want by typing in a simple text query in a search box or speaking to your smart phone that converts speech to text. The search engine and related advertisers will feed users advertisements relating to your search, in essence, helping you find what you want. Many times, unfortunately for the person searching, advertisements may continue even after users have found and purchased what they wanted. One or more embodiments do not relate to helping users find what they want, instead they offer users something they may not even have thought of wanting or needing at that particular moment. But because a display is in front of them, it now has their attention and, ideally, entices users to pursue it. The particular goods and/or services offered become an “impulse purchase.”

Advances in smart TV technology have made accessing the Internet without the use of a computer extremely easy. In response to all the entertainment content available on the Internet, TV manufacturers have added web browser capabilities to televisions to facilitate the process of streaming video. Therefore, users do not need a dedicated computer in order to access online content. Additionally, many smart TVs incorporate a universal serial bus (USB) receptacle to be able to transfer computer files from a USB flash drive, which eliminates the need for an Internet connection for the purpose of displaying video content, including advertising.

TV-sized video monitors may now be used more as displays for things other than entertainment. One or more embodiments benefit from this because most computers use a relatively small display to present content and advertising. The larger displays are more beneficial for presenting advertising in a public or out-of-home environment. And, a public environment is usually not a place where users would use a computer to search for goods and/or services. Instead, in that instance users would likely use a smart phone, which has an even smaller screen.

An impulse purchase is a concept that retailers use when merchandising products they want to “move” or sell more than other products. To accomplish this, retailers place those items on an end cap (the very end segment of a longer merchandising display, generally having an aisle on either side), in the center walkway of an aisle, or on a freestanding display within the aisle or other open area. Here, those products are much more noticeable and therefore, more likely to attract attention. Whether shoppers intended to buy that product or not, it is now readily visible. In that small amount of time, usually fractions of a second, shoppers subconsciously make a decision to buy that product, that is, they make an impulse buy.

The pervasiveness of smart phones and the ease with which they can connect to the Internet, makes it easy to find, and increasingly more important, to pay for goods. Advances with mobile payment systems allow smart phone users to avoid using credit card numbers to complete a payment. Entering one's personal and payment information is usually made well in advance using apps such as, APPLE PAY®, PAYPAL®, or GOOGLE WALLET®, all of which facilitate the mobile and online payment process. This segment of mobile computing and mobile commerce continues to grow. Eventually, a simple “buy” button activation and a security confirmation, may complete a purchase and have a good shipped to a shopper's door or a service implemented on their behalf. This makes purchasing goods advertised while shoppers are away from home, that much easier to buy. There is no need to know what they want and then search the Internet as these goods and/or services are brought to them. If presented in an environment in which shoppers feel comfortable, and in a manner that is appealing, the advertisement should be capable of enticing them to buy the product offered. One or more embodiments exploits these factors based on essentially shrinking an outdoor board (displaying advertisements on a smart TV), having the advertisements displayed more finely targeted to somewhat of a limited public access (selected by an Advertising Affiliate (“AdAff”) that is a business owner while taking into consideration the wants and needs of his/her customers), and having a quick means of directly responding to the advertising and completing a purchase transaction (e.g., accessing an e-commerce website with a smart phone). Advertisements for products users may not have thought of needing, in this environment those products advertised become slightly more appealing if brought to shopper attention, rather than if a shopper had to track them down using a smart phone or going home to use a desktop or laptop computer. The product is displayed in front of shoppers, and if the advertisement is appealing enough, it entices a shopper to further the process by interacting with it. For one or more embodiments, the interaction takes the simple form of scanning a bar code, entering a URL, or using wireless technology (e.g., near field communication (NFC), Wi-Fi, BLUETOOTH®, etc.) to link to the e-commerce website selling the good and/or service.

In one or more embodiments, the AdAff: chooses to be part of a captive network of advertisers for a specific e-commerce website; does not need to have their own website to participate as an advertiser; selects from the e-commerce website the goods and/or services they desire to advertise; is not “fed” advertisements to its website as is current Internet advertising practice; may use a smart TV to display a web page to his/her customers, such that a dedicated computer is not required; can utilize the USB port of the smart TV to download content from a flash drive so that an Internet connection is not required; utilizes the Internet's digital medium to advertise in a more passive format, i.e., it is essentially “a product searching for a customer” (the advertising is not search engine-related, i.e., resulting from a computer user's search queries and related keywords, or a customer searching for a product); and displays the web page on a relatively large, video monitor in an area of high traffic and high visibility within or adjacent their business establishment (the advertisements are not delivered to a consumer's relatively smaller, computer monitor, generally in the privacy of their home).

One or more embodiments comprise a hybrid approach to marketing or advertising in that it has some of the elements of broadcast advertising (i.e., it is displayed to the general public, like a billboard), but also utilizes many aspects of narrow-cast advertising (i.e., the goods and/or services displayed are targeted by the AdAff to their customers, their tastes, their neighborhood, and more importantly, the environment within which the AdAff's customers see the advertisement, i.e., the location of the video monitor displaying the advertisement within or adjacent their business establishment, or public space), while avoiding the pay-per-click stigma and other issues related to online advertising abuses. It is in the AdAff's best interest to select the goods and/or services they believe their customers will like to improve the probability of making a purchase of the goods and/or services by their customer (i.e., the AdAff has a financial incentive).

One or more embodiments provide that a fully functioning e-commerce website is created by an otherwise, and alternatively known, first party with customers, otherwise and alternatively known as second parties (or singularly, party), and the ability of embodiments of the invention to integrate into the functionality of that e-commerce website, and by the creation of at least one web page by an outside AdAff (otherwise and alternatively known as a third party) given secure access to the e-commerce website for the purpose of advertising the web page(s) created, for the purpose of receiving a commission on sales associated with entry into the website via the page(s) that results in a corresponding sale made by the website owner. The AdAff is a business person or public official (in the case of video monitors that display the advertisements in public places, e.g., a public library) that desires to add a new revenue source to their operations from advertising proceeds tied to the display of advertising for an e-commerce business, and purchases made by customers entering the e-commerce website web page upon seeing and directly responding to the advertising, by means of the customer entering the e-commerce website via entering a text string, scanning the graphical code displayed on the web page or using wireless signals, using their portable computing device.

One embodiment includes the process by which the AdAff builds a specific web page(s) within the first-party's e-commerce website that they will eventually display on a video monitor in the AdAff s establishment, business, or otherwise, public space. This process involves a web page wireframe construction that calls and integrates the various page components such as the product image, product description, unique identifying text string of the web page, graphical code associated with the web page and/or wireless signals, to create a finished web page, as determined and desired by the AdAff for display on a video monitor.

The AdAff is in a unique position to tailor the selection of goods and/or services they choose to include for display on the web page they create on the e-commerce website using the knowledge of their customer base and what they feel might be appropriate for their customers, or what goods and/or services might be appropriate for the corresponding area in which the display is mounted (e.g., mounting a display in the fiction book section of a library where mystery novels are available and advertising books that are of the mystery genre rather than say, children's books; or mounting a display in the garden section of a home improvement center and displaying ads of the services of gardeners rather than the services of plumbers, and to further tailor the selection by only selecting local gardeners to display, not gardeners whose businesses are unreasonably far away from where the home improvement center's customers would generally live). A few possible examples of the application of one or more embodiments may include, but not limited to: displaying a customized web page(s) for: a book(s) in a library; music in a coffee shop; for art in a restaurant; services of a plumber, electrician, gardener, etc., at a home improvement store; services of a hair stylist at a health club or fitness center, etc. Additionally, the selection of the particular goods and/or services may be temporal, seasonal, etc. as appropriate.

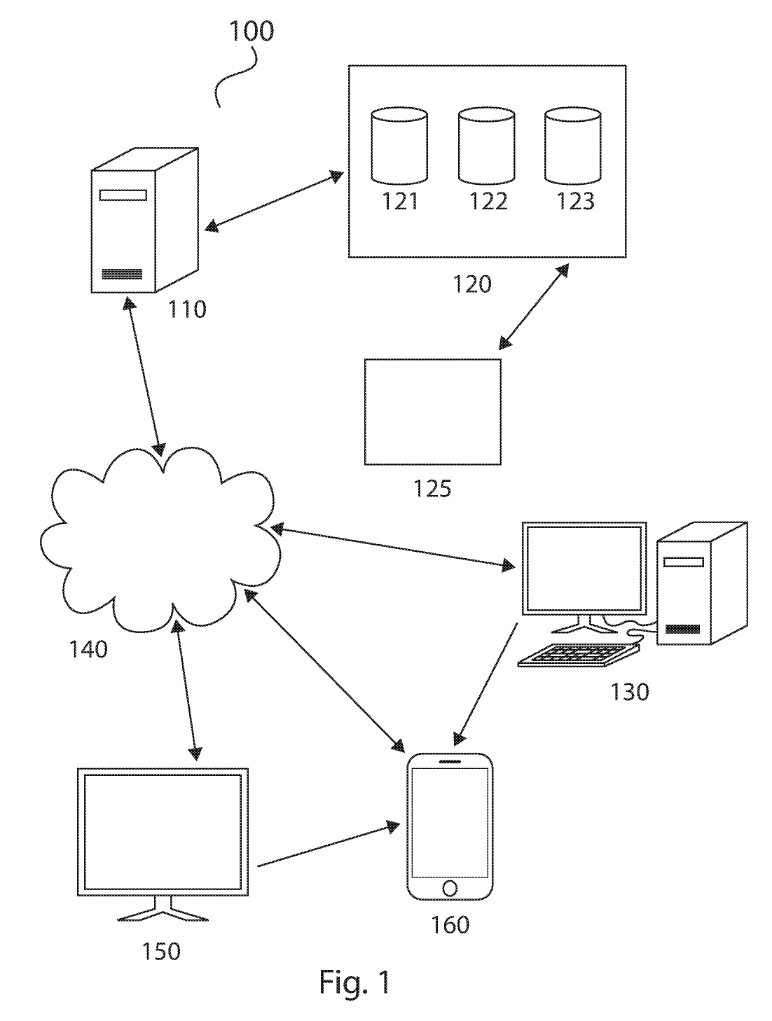

FIG. 1 illustrates a captive network of advertising affiliates (CNAA) system 100, according to an embodiment. In one embodiment, the CNAA system 100 includes a web server 110 (e.g., a hardware server, cloud environment server, etc.), at least one e-commerce website 120, a communication network 140 (e.g., public network (e.g., Internet), WAN, etc.), a connected computing device 130 including a monitor, and a video monitor 150 (e.g., a browser or application capable smart TV). The e-commerce website 120 may include or be connected with multiple databases, such as a database 121 of information associated with goods and/or services. In one example, the information may include: images, descriptions, pricing, goods inventory, location, etc. A database 122 of information for one or more AdAffs. In one example, the AdAff information may include: personal information: name, address, banking information, unique identifiers assigned when an AdAff creates a web page (as stored in database 123), etc., and a database 123 of web page data that may include information contained in each web page, such as: the goods and/or services information (as from database 121) selected by an AdAff, assigned objects (e.g., unique identifier codes, graphical codes, links, text strings, etc.) and signal identification (e.g., identification for: radio frequency (RF) signals, NFC signals, BLUETOOTH® signals, etc., or future available signals, such as light coding (e.g., infrared, electromagnetic radiation (EMR) technology, etc.).

In one embodiment, web page 125 is a web page of the e-commerce website 120 that is created within the e-commerce website 120 by an AdAff, and whose contents may be referenced from database 123. In one example, the web page 125 may be generated from an application or user interface based on selecting a particular product or good from the e-commerce website 120. In one example, the web page 125 may be customized by the AdAff through a web page generation/editing application, from customizable web page formats, with customized video, sound, etc.

In one embodiment, the connected computing device 130 and/or the video monitor 150 may be used to display a particular product or service selected by the AdAff for display in a particular location selected by the AdAff (e.g., at the AdAff s business location, a public space, etc.). In one embodiment, a portable computing device or mobile electronic device 160 may be used to scan a graphical object (e.g., a QR code), enter a link (e.g., a URL), a hypertext transfer protocol (HTTP) cookie, receive a signal (e.g., RF, NFC, etc.), etc. from the connected computing device 130 or the video monitor 150. The scanned graphical object, link or received signal connects a browser or app to the web page 125.

In one embodiment, the web server 110 includes a memory device or is connected to a memory device that stores instructions and one or more processors that execute the instructions. The web server 110 may receive a selection for displaying a particular good and/or a particular service from the e-commerce website 120, create a customized web page 125 using content from or by the e-commerce website 120 based on execution of: a tool, an app, an editor, a script, a function, a feature, menus, drag-and-drop, etc., generate an object or signal on the customized web page 125, displaying the customized web page 125 on a display device (e.g., computing device and monitor 130 or video monitor 150) at a particular location (e.g., targeted to: a particular department in a store, a particular store, a public place for a particular event, etc.), and receive a selection for a transaction (e.g., a purchase or agreement) for the particular good and/or the particular service. In one embodiment, the portable computing device or mobile electronic device 160 converts the object or signal to display another web page on the e-commerce website that receives the selection for the transaction.

In one embodiment, an application for the e-commerce website 120 tracks the transaction for the particular good and/or the particular service that is displayed at the particular location by the AdAff for another transaction (e.g., incentive transaction, commission transaction, etc.) between the e-commerce website 120 and the AdAff. In one example, the purchase of the particular good and/or service by a consumer using the portable computing device or mobile electronic device 160 results in the AdAff receiving an incentive or commission from the e-commerce website 120 at a particular time of the month, end of the day, upon verification of payment, etc. In one example, the e-commerce website 120 is associated with a first party (e.g., owner of the e-commerce website 120), the portable computing device or mobile electronic device 160 is associated with a second party (e.g., a consumer) and the affiliate advertiser is a third party (e.g., a business owner, company, etc.).

In one embodiment, the AdAff continuously displays the web page 125 created within and integral to the e-commerce website 120 residing on the web server 110 during the AdAff s generally normal business hours and making viewing on the connected computing device 130 or the video monitor 150 convenient for the general public. It should be noted that the AdAff need not have a network 140 connection to display the web page 125 that they created as the information from the web page 125 can be downloaded to a flash drive (not shown) connected to the computing device 130. That is, a flash drive can be removably attached to a non-Internet connected computer or non-Internet connected video monitor by way of a USB port (not illustrated) and the images of the at least one good and/or service integral to the web page 125 can be displayed continuously, for example, as if in a slide show format.

A buyer, interested in the goods and/or services, using the portable computing device or mobile electronic device 160, with an Internet-connected 140 web browser (e.g., via Wi-Fi, cellular network, etc.), may either scan the graphical code seen on the video monitor 150 (e.g., through an app., using an integrated camera, or through technologies such as BLUETOOTH®, NFC, etc.), or the monitor of the computing device 130, displaying the web page 125, or enter a text string for a link, shown on the video monitor 150, or the monitor of the computing device 130, displaying the web page 125 into the portable computing device or mobile electronic device 160 web browser either of which actions link the buyer directly to the e-commerce website 120 web page 125 to facilitate the purchase of the goods and/or services selected by the AdAff and as correlated to the AdAff in database 123. In one example, the AdAff earns a commission for purchases made on the e-commerce website 120 that were consummated by a buyer using the web page 125 created by the AdAff as the buyer's point-of-entry into the e-commerce website 120.

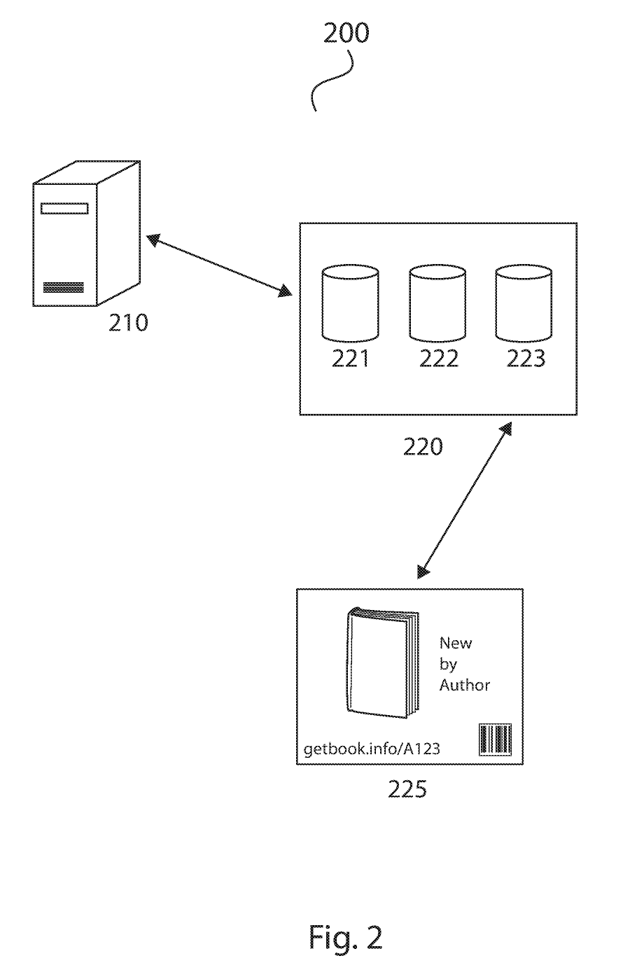

FIG. 2 illustrates an example e-commerce system 200 for the e-commerce website 120 that may be implemented by an embodiment. In one embodiment, the system 200 includes a webserver 210 (e.g., a hardware server device, a cloud environment computing device, etc.), an e-commerce website 220 (similar to e-commerce website 120 (FIG. 1)) and an example customized web page 225 created within the e-commerce website 220 by an AdAff, and whose contents may be referenced from database 223. In one example, the web page 225 may be generated from an application or user interface based on selecting a particular product or good from the e-commerce website 220. In one example, the web page 225 may be customized by the AdAff through a web page generation/editing application, from customizable web page formats, with customized video, sound, etc.

The e-commerce website 220 may include or be connected with multiple databases, such as a database 221 of information associated with goods and/or services. In one example, the information may include: images, descriptions, pricing, goods inventory, location, etc. A database 222 of information for AdAffs. In one example, the AdAff information may include: personal information: name, address, banking information, unique identifiers assigned when an AdAff creates a web page (as stored in database 223), etc., and a database 223 of web page data that may include information contained in each web page, such as: the goods and/or services information (as from database 221) selected by an AdAff, assigned objects (e.g., unique identifier codes, graphical codes, links, text strings, etc.) and signal identification (e.g., identification for: RF signals, NFC signals, etc., or future available signals, such as light coding (e.g., infrared, EMR technology, etc.). In one example, the customized web page 225 includes an example good (e.g., a book) with an example QR code and URL.

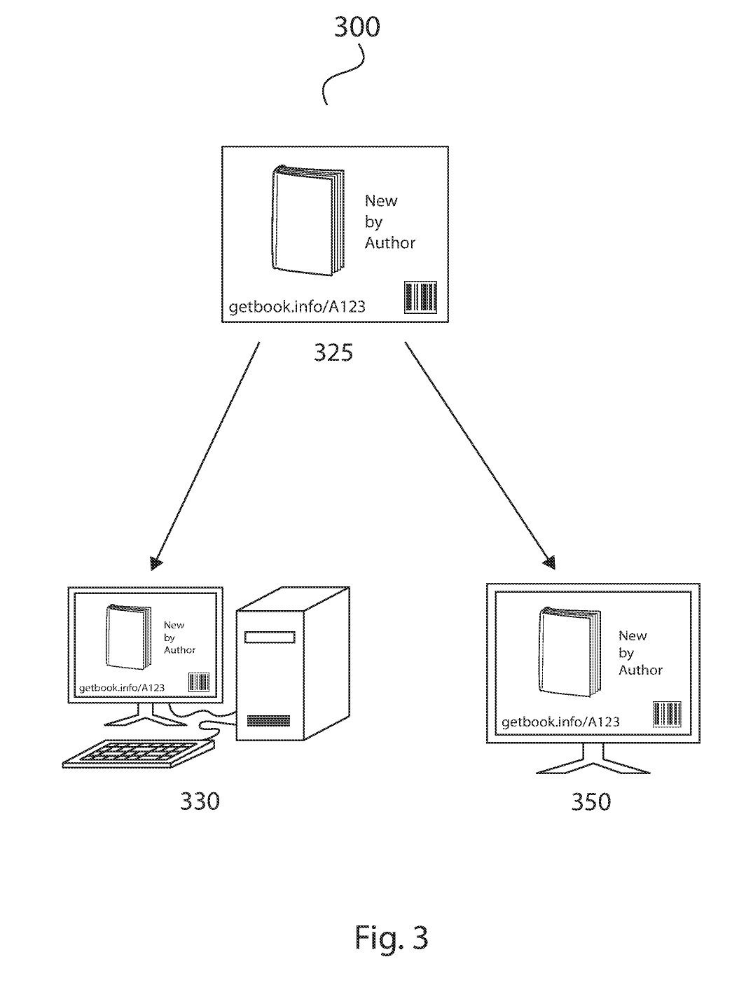

FIG. 3 illustrates an example representation of an advertisement or marketing tool 300 and its delivery including a web page 325 displayed on a video monitor(s) 350 and/or a computing device 330. In one example, the web page 325 of the e-commerce website (created within the site through actions of an AdAff, and whose contents is referenced from database 223 (FIG. 2). In one example, the computing device 330 displays the e-commerce website 220 web page 325 (e.g., an advertisement for a new book) created by an AdAff. The video monitor 350 (e.g., a smart TV) is shown displaying the web page 325 (e.g., the advertisement for the new book).

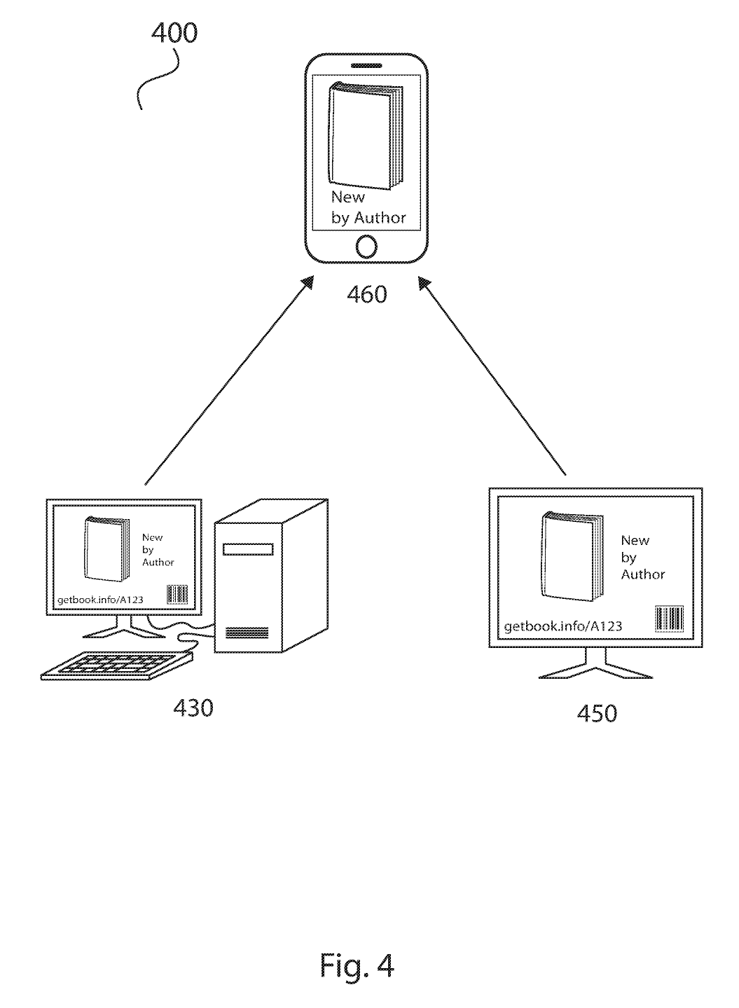

FIG. 4 illustrates an example representation 400 including a portable computing device 460 connected to, and displaying an example of a web page (e.g., web page 325, FIG. 3) on an e-commerce website 220 (FIG. 2) that may be implemented by an embodiment. In one example, a computing device 430 with a monitor displays the e-commerce website 220 web page 325 (FIG. 3) created by an AdAff. In this example, a video monitor 450 (e.g., a smart TV) displays the web page 325 created by an AdAff. Additionally, a mobile computing device 460 (e.g., a smart phone) displays the web page 325. In one embodiment, the portable computing device 460 is used by a customer of the AdAff s at the place that the AdAff has selected to stage or place the video monitor 450 and the computing device 430 with a monitor. Of course, different combinations of computing devices 430 with one or more monitors and/or video monitors 450 may be implemented throughout a location or in strategic placements.

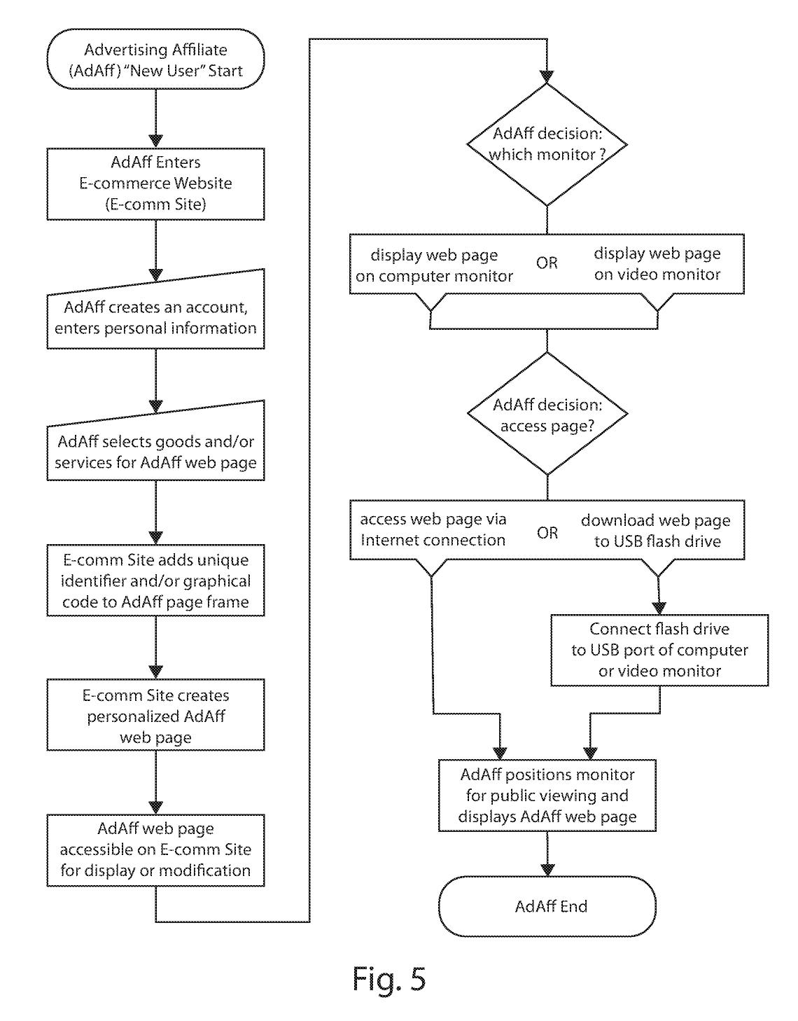

FIG. 5 illustrates a block diagram of a process for an advertising affiliate creating a web page (e.g., web page 125, 225, 325) and displaying the web page for advertising goods and/or services selected from an e-commerce website (e.g., e-commerce website 120, 220), according to an embodiment. In one embodiment, the process includes an AdAff (e.g., a new user) signs up and enters the e-commerce website. The AdAff creates an account on the e-commerce website and enters personal information (e.g., name of contact, title, entity, contact information, banking information, ID, preferences, etc.). The AdAff then selects good(s) and/or service(s) from the listing or depiction of goods and/or services from the e-commerce website. In one embodiment, the e-commerce website adds a unique identifier and/or graphical code (e.g., a QR code) to the AdAff page frame. In other embodiments, unique wireless signals may be associated with the page frame. The e-commerce website then creates/generates a new personalized/customized AdAff web page for the selected good(s) and/or service(s). The AdAff web page is then accessible on the e-commerce website for display and/or modification by the AdAff (e.g., using webpage editing tools, apps, etc.).

In one embodiment, the AdAff determines whether to select display of the customized AdAff webpage on a computing device with one or more monitors (e.g., computing device 130, FIG. 1, 330, FIG. 3, 430, FIG. 4) or one or more video monitors (e.g., video monitor 150, FIG. 1, 350, FIG. 3, 450, FIG. 4). The AdAff then determines how to access the AdAff webpage, either through a network connection (e.g., the Internet), or to download and use a flash drive on a USB port of a computing device or video monitor. If the AdAff selects a flash drive, the flash drive(s) is/are connected to the computing device(s) or video monitor(s). The AdAff positions the displays in the appropriate location or uses an app to select where to send the webpage in a network of display devices. The process may also include determining when to display the webpage on which display devices, sequences of webpages to display, audio to associate with the webpage display or through a separate device or lighting effects, which may draw attention to the display(s) of the webpages, etc.

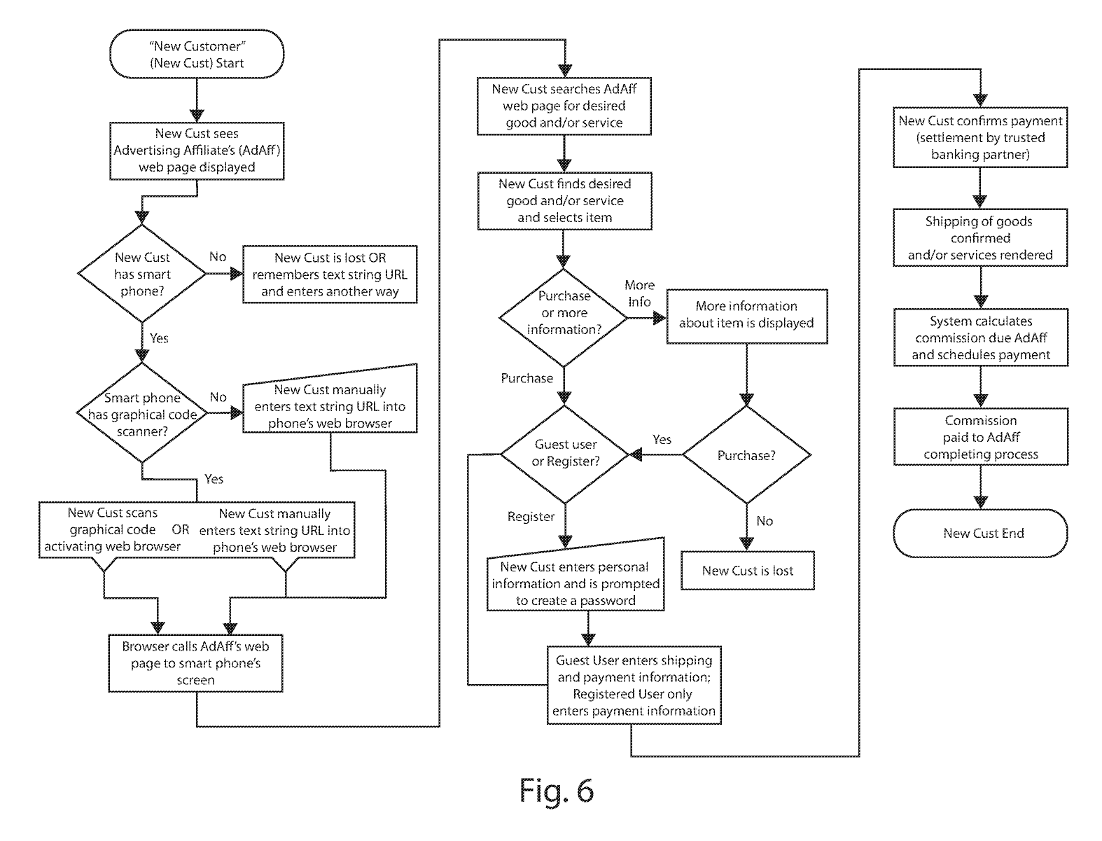

FIG. 6 illustrates a block diagram of a process for utilizing information derived from an advertising affiliate-created e-commerce website web page, according to an embodiment. In one embodiment, the process for a new customer starts, and the new customer or shopper views the AdAff webpage displayed on one or more AdAff computing devices with a monitor(s) and/or video monitor(s). If the new customer is using a smart phone or other mobile computing device, and an app to scan an object (e.g., a QR code), the new customer scans the object to activate a browser (or app) or receives a link to manually enter into a browser or app. If the new customer does not have a smart phone or other mobile computing device, they may write down a link or save the link another way (e.g., writing down). If the new user manually enters a link/URL, or otherwise accesses the AdAffs webpage through their device, they can find the goods/services that they desire. It should be noted that with wireless technology associated with the AdAff webpage, the AdAff webpage may be automatically displayed on the new customer's device without the new customer having to enter a link, text string, scan the object, etc.

Once the new customer finds the desired goods and/or services, a selection is received by the e-commerce website. The new customer may be shown more information or may be directed to another webpage to begin a transaction for purchasing the selected good(s) and/or service(s). If the new customer selected to see further information, that information is then displayed (e.g., reviews, detailed description, user manuals, FAQs, etc.). The process then queries the new customer to register or proceed as a guest once the selection for proceeding to purchase is received. The new customer is queried to enter personal information, and to create a username and password. If the new customer does not reply to the query, the new customer is lost in the process and the process waits until timing out at a pre-selected time period (e.g., five minutes, ten minutes, etc.).

After entering personal information, the new customer is prompted for shipping information and payment information, unless the new customer uses automated NFC payment technology, an e-wallet, etc., which can make the process streamlined and automatic. Once the new customer confirms the payment information or method, the process proceeds for settlement with a banking partner or other payment partner.

The new customer may receive an indication of the completion of the process view an email, text message or other indication on their mobile computing device. Once the shipping is confirmed, further notifications may be made to the new customer. In one embodiment, once the product(s) are delivered and/or service(s) are rendered, the e-commerce website commences another transaction to determine a commission or fee to pay to the AdAff, and completes the transaction through an automated process based on the AdAff information or profile.

It is understood in advance that although this disclosure includes a detailed description of cloud computing, implementation of the teachings recited herein are not limited to a cloud computing environment. Rather, embodiments are capable of being implemented in conjunction with any other type of computing environment now known or later developed

Cloud computing is a model of service delivery for enabling convenient, on-demand network access to a shared pool of configurable computing resources (e.g., networks, network bandwidth, servers, processing, memory, storage, applications, virtual machines (VMs), and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed and automatically, without requiring human interaction with the service's provider.

Broad network access: capabilities are available over a network and accessed through standard mechanisms that promote use by heterogeneous, thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned and, in some cases, automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active consumer accounts). Resource usage can be monitored, controlled, and reported, thereby providing transparency for both the provider and consumer of the utilized service.

Service models are as follows:

Software as a Service (SaaS): the capability provided to the consumer is the ability to use the provider's applications running on a cloud infrastructure. The applications are accessible from various client devices through a thin client interface, such as a web browser (e.g., web-based email). The consumer does not manage or control the underlying cloud infrastructure including network, servers, operating systems, storage, or even individual application capabilities, with the possible exception of limited consumer-specific application configuration settings.

Platform as a Service (PaaS): the capability provided to the consumer is the ability to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application-hosting environment configurations.

Infrastructure as a Service (IaaS): the capability provided to the consumer is the ability to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is a service oriented with a focus on statelessness, low coupling, modularity, and semantic interoperability. At the heart of cloud computing is an infrastructure comprising a network of interconnected nodes.

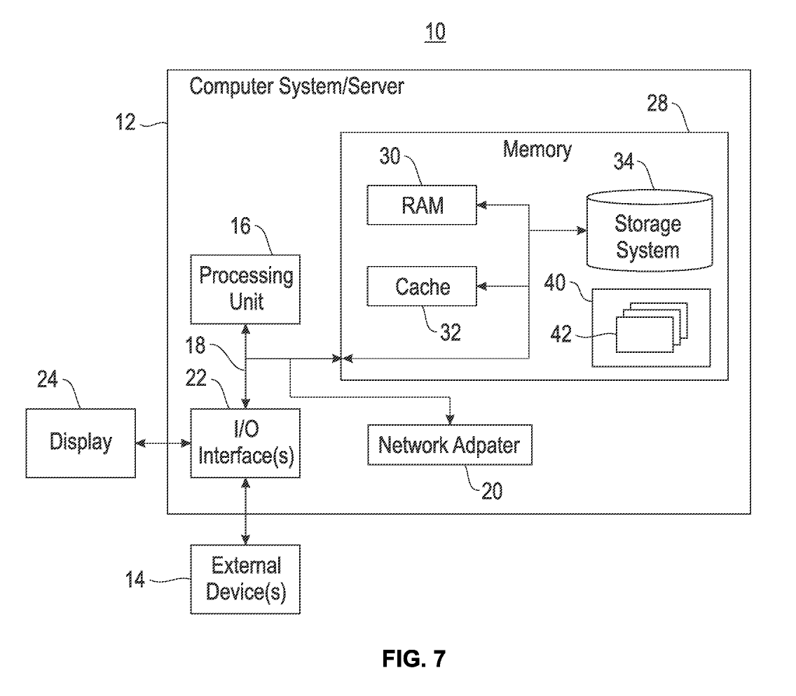

Referring now to FIG. 7, a schematic of an example of a cloud computing node is shown. Cloud computing node 10 is only one example of a suitable cloud computing node and is not intended to suggest any limitation as to the scope of use or functionality of embodiments described herein. Regardless, cloud computing node 10 is capable of being implemented and/or performing any of the functionality set forth hereinabove.

In cloud computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 7, computer system/server 12 in cloud computing node 10 is shown in the form of a general purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example and not limitation, such architectures include a(n) Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile/non-volatile media, and removable/non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, a storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of the embodiments.

Program/utility 40, having a set (at least one) of program modules 42, may be stored in a memory 28 by way of example and not limitation, as well as an operating system, one or more application programs, other program modules, and program data. Each of the operating systems, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14, such as a keyboard, a pointing device, etc.; a display 24; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks, such as a LAN, WAN, and/or a public network (e.g., the Internet) via a network adapter 20. As depicted, the network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, data archival storage systems, etc.

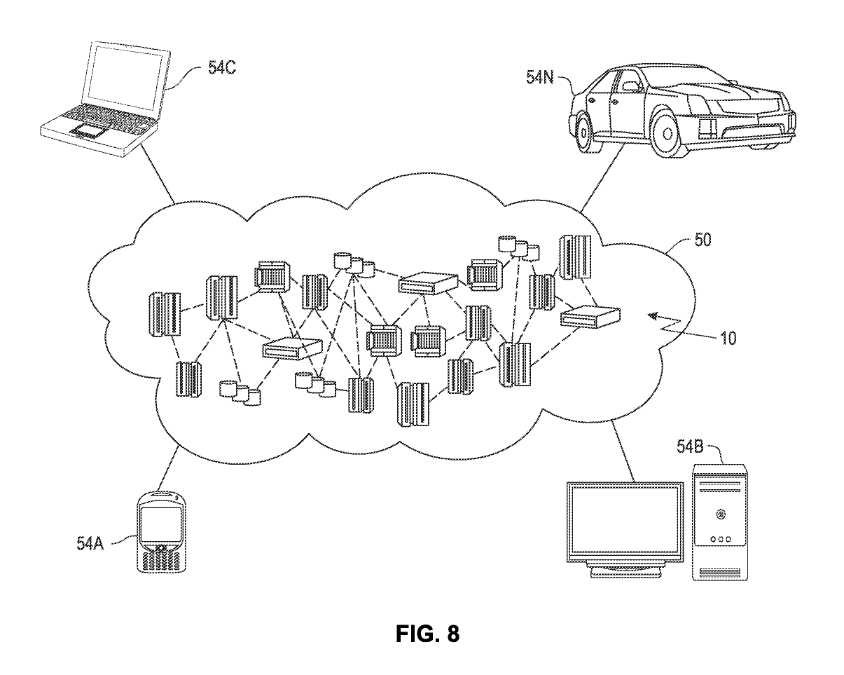

Referring now to FIG. 8, an illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as private, community, public, or hybrid clouds as described hereinabove, or a combination thereof. This allows the cloud computing environment 50 to offer infrastructure, platforms, and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

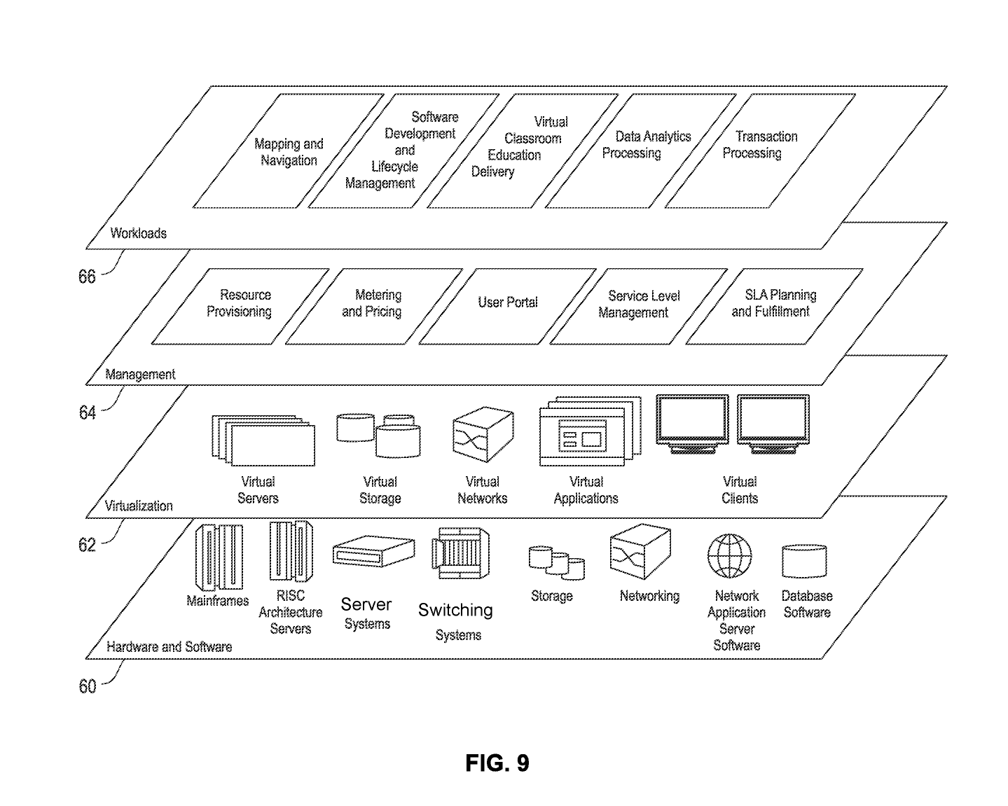

Referring now to FIG. 9, a set of functional abstraction layers provided by the cloud computing environment 50 (FIG. 8) is shown. It should be understood in advance that the components, layers, and functions shown in FIG. 9 are intended to be illustrative only and the embodiments are not limited thereto. As depicted, the following layers and corresponding functions are provided:

Hardware and software layer 60 includes hardware and software components. Examples of hardware components include mainframes; RISC (Reduced Instruction Set Computer) architecture based servers; storage devices; networks and networking components. Examples of software components include network application server software; and database software.

Virtualization layer 62 provides an abstraction layer from which the following examples of virtual entities may be provided: virtual servers; virtual storage; virtual networks, including virtual private networks; virtual applications and operating systems; and virtual clients.

In one example, a management layer 64 may provide the functions described below. Resource provisioning provides dynamic procurement of computing resources and other resources that are utilized to perform tasks within the cloud computing environment. Metering and pricing provide cost tracking as resources are utilized within the cloud computing environment and provide billing or invoicing for consumption of these resources. In one example, these resources may comprise application software licenses. Security provides identity verification for cloud consumers and tasks as well as protection for data and other resources. Consumer portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing. As mentioned above, all of the foregoing examples described with respect to FIG. 9 are illustrative only, and the embodiments are not limited to these examples.

It is understood all functions of one or more embodiments as described herein may typically performed by the system 100 (FIG. 1), which can be tangibly embodied as modules of program code 42 of program/utility 40 (FIG. 7). However, this need not be the case. Rather, the functionality recited herein could be carried out/implemented and/or enabled by any of the layers 60-66 shown in FIG. 9.

It is reiterated that although this disclosure includes a detailed description on cloud computing, implementation of the teachings recited herein are not limited to a cloud computing environment. Rather, the embodiments may be implemented with any type of clustered computing environment now known or later developed.

As will be appreciated by one skilled in the art, aspects of embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments are described below with reference to flowchart illustrations and/or block diagrams of methods, apparatus (systems) and computer program products according to the embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method comprising:
providing at least one of goods and services on an e-commerce website;
receiving a selection for displaying at least one of a particular good and a particular service;
creating at least one customized web page for displaying at least one of the particular good and the particular service based on the e-commerce website, wherein the at least one customized web page is associated with an affiliate advertiser;
generating a graphical code or a link for display on the at least one customized web page;
displaying the at least one customized web page on a display device at a particular location; and
receiving a selection for a transaction for at least one of the particular good and the particular service from another web page on the e-commerce website that is launched based on conversion of the graphical code or the link.

2. The method of claim 1, wherein the graphical code is a quick response (QR) code, and the link is a data segment or a hypertext transfer protocol (HTTP) cookie.

3. The method of claim 1, wherein an application tracks the transaction for the at least one of the particular good and the particular service that is displayed at the particular location by the affiliate advertiser for another transaction between the e-commerce website and the affiliate advertiser.

4. The method of claim 1, wherein the particular location comprises a location within or adjacent a business of the affiliate advertiser or a public space.

5. The method of claim 1, wherein the conversion is performed by a mobile electronic device, and the mobile electronic device includes an Internet-connected web browser or application.

6. The method of claim 5, wherein creating the at least one customized web page comprises:
integrating multiple web page components from the e-commerce website including one or more of: a product image, a product description, a unique identifying text string of the customized web page, and a graphical code associated with the customized web page.

7. The method of claim 5, wherein the e-commerce website is associated with a first party, the mobile electronic device is associated with a second party and the affiliate advertiser is a third party.

8. A non-transitory processor-readable medium that includes a program that when executed by a processor performs a method comprising:
receiving a selection for displaying at least one of a particular good and a particular service from an e-commerce website;
creating at least one customized web page for displaying at least one of the particular good and the particular service based on the e-commerce website, wherein the at least one customized web page is associated with an affiliate advertiser;
generating an object or signal for the at least one customized web page;
displaying the at least one customized web page on a display device at a particular location; and
receiving a selection for a transaction for at least one of the particular good and the particular service from another web page on the e-commerce website that is launched based on conversion of the object or the signal.

9. The non-transitory processor-readable medium of claim 8, wherein the object is a quick response (QR) code, a data segment link or a hypertext transfer protocol (HTTP) cookie, and the signal comprises a radio frequency (RF) signal, a Bluetooth® signal or a near field communication (NFC) signal.

10. The non-transitory processor-readable medium of claim 8, wherein an application tracks the transaction for the at least one of the particular good and the particular service that is displayed at the particular location by the affiliate advertiser for another transaction between the e-commerce website and the affiliate advertiser.

11. The non-transitory processor-readable medium of claim 8, wherein the particular location comprises a location within or adjacent a business of the affiliate advertiser or a public space.

12. The non-transitory processor-readable medium of claim 8, wherein the conversion of the object or the signal is performed using a mobile electronic device that includes an Internet-connected web browser or application.

13. The non-transitory processor-readable medium of claim 12, wherein creating the at least one customized web page comprises:
integrating multiple web page components from the e-commerce website including one or more of: a product image, a product description, a unique identifier for the object or signal associated with the customized web page.

14. The non-transitory processor-readable medium of claim 12, wherein the e-commerce website is associated with a first party, the mobile electronic device is associated with a second party and the affiliate advertiser is a third party.

15. A server comprising:
a memory device storing instructions;
one or more processors configured to execute the instructions to:
receive a selection for displaying at least one of a particular good and a particular service from an e-commerce website;
create at least one customized web page to display at least one of the particular good and the particular service based on the e-commerce website, wherein the at least one customized web page is associated with an affiliate advertiser;
generate an object or signal on the at least one customized web page;
display the at least one customized web page on a display device at a particular location; and
receive a selection for a transaction for at least one of the particular good and the particular service.

16. The server of claim 15, wherein a mobile electronic device is configured to convert the object or signal to display another web page on the e-commerce website that is configured to receive the selection for the transaction.

17. The server of claim 16, wherein the object is a quick response (QR) code, a data segment link or a hypertext transfer protocol (HTTP) cookie, and the signal comprises a radio frequency (RF) signal, a Bluetooth® signal or a near field communication (NFC) signal.

18. The server of claim 16, wherein an application is configured to track the transaction for the at least one of the particular good and the particular service that is displayed at the particular location by the affiliate advertiser for another transaction between the e-commerce website and the affiliate advertiser, and the particular location comprises a location within or adjacent a business of the affiliate advertiser or a public space.

19. The server of claim 16, wherein the mobile device includes an Internet-connected web browser or application.

20. The server of claim 16, wherein:
the at least one customized web page comprises integrated web page components from the e-commerce website including one or more of: a product image, a product description, a unique identifying text string of the customized web page, and a graphical code associated with the customized web page;
the e-commerce website is associated with a first party;
the mobile electronic device is associated with a second party; and
the affiliate advertiser is a third party.
